(19) United States
(12) Patent Application Publication
(10) Pub. No.: US 2005/0087653 A1
(43) Pub. Date: Apr. 28, 2005

(54) Parachute (survival air guard)

(76) Inventor: Kurt Koch, Aschaffenburg (DE)

Correspondence Address: MERCHANT & GOULD PC, P.O. BOX 2903, MINNEAPOLIS, MN, 55402-0903, US

(21) Appl. No.: 10/492,501

(22) PCT Filed: Oct. 4, 2002
(86) PCT No.: PCT/EP02/11161

(30) Foreign Application Priority Data
Oct. 12, 2001 (DE) 101 50 289.3
Oct. 26, 2001 (DE) 101 52 299.1

(51) Int. Cl. B64D 19/00

(52) U.S. Cl. 244/142

(57) ABSTRACT

The invention relates to a parachute (Survivial Air Guard), preferably applicable in an extreme life-threatening emergency situation. The parachute is particularly embodied as a round parachute and comprises a canopy which is connected to the parachute harness by means of several rigging lines. According to the invention, a parachute which opens quicker than conventional parachutes on usage in emergency situations may be achieved, whereby the canopy is provided with an unfurling and stablizing device for rapid unfurling and preferably stabilizing. The device is preferably fixed to the parachute, preferably within the parachute canopy, and preferably comprises a rapidly-inflating inflation system, preferably with gas generators, preferably airbag systems. In a further embodiment of the invention the parachute is integrated in a survival case.

The invention relates to a parachute (SURVIVAL-AIR-GUARD), preferably applicable in an extreme life-threatening emergency situation.

Its use should only occur when all previously known rescue methods and possibilities are no longer usable and/or are not available. Its use is intended, for example, especially in dangerous situations for people in skyscrapers, observation towers and similar buildings when all usual rescue contrivances and ways of escape down are no longer reachable and/or cut off. There are likewise widespread possibilities for application, for example for certain trade groups, in sports or in military areas. By itself, the special round canopy parachute (SURVIVAL-AIR-GUARD), preferably integrated in a survival case, because of a special design and construction offers multiple objective applications.

The parachute is specially-constructed as a round canopy parachute and displays a canopy that is joined with the parachute by means of several rigging lines.

A parachute that opens more rapidly than conventional parachutes in emergency situations is achieved in accordance with the invention in that the canopy is associated to an opening and stabilizing device for rapidly unfurling and preferably stabilizing the canopy. The device is associated with the parachute. The device is preferably attached to the parachute, preferably inside the parachute canopy, and preferably displays a rapidly inflating inflation system, preferably an air bag system.

Other advantageous features and embodiments of the invention are presented in the claims and in the following description.

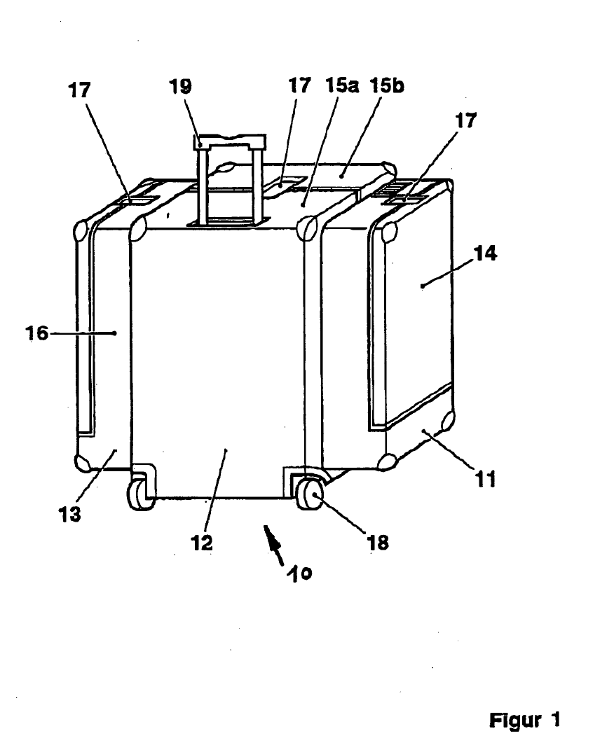

The survival case (SURVIVAL CASE) 10 in accordance with FIG. 1 is, in practice, made of a light metal (aluminum) or of a suitable synthetic (e.g. polycarbonate, carbon fiber), and divided into three compartments 11, 12, 13 which, in the stand-by condition, are provided with lids 14, 15, 16 or closure caps, preferably covers, preferably locked. These are equipped with easily operable hinged locks or functionally comparable locking elements 17. Placed in these compartments 11, 12, 13 are all tools and equipment required for an extreme emergency at a great height, arranged in the order corresponding to the rescue procedure. The case 10 is additionally equipped with rollers 18 as well as with a displaceable (movable, adjustable) grip system 19.

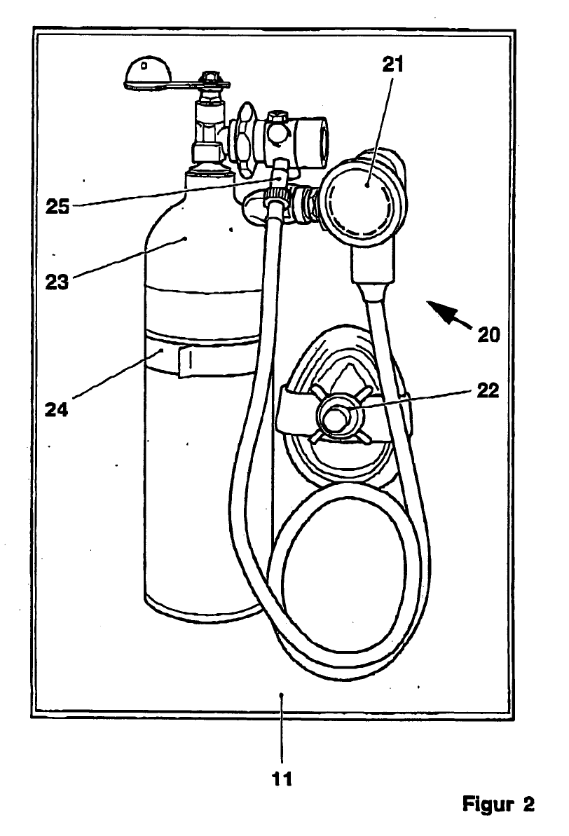

Provided are a left (13), a center (12) and an outer (11) compartment. According to FIG. 2, located in compartment 11 is a commercial breathing device (oxygen breathing device) 20 consisting of a breathing regulator 21, breathing mask 22 or breathing mouthpiece. Nose clips or mouth/nose breathing masks, oxygen bottle 23, preferably 300 bar composite bottles with a harness system 24 for changing out the air bottle are accommodated. Also selectably capable of being employed are other breathing devices that are usual as in the mining industry or the navy, for example.

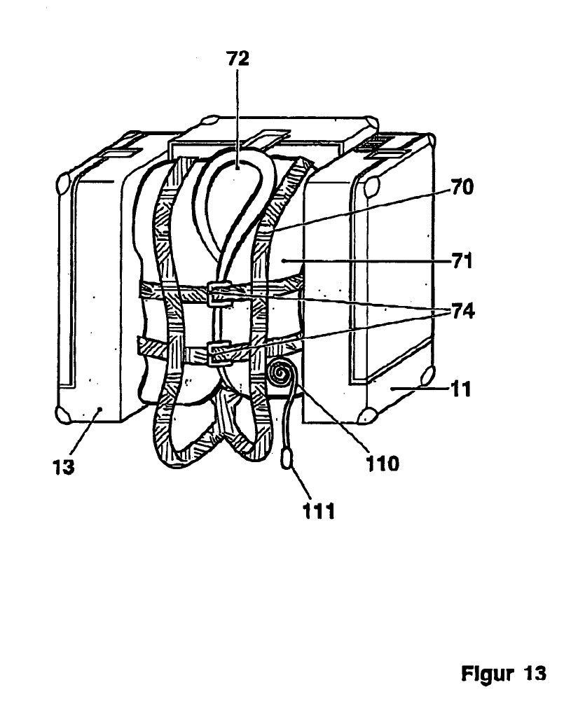

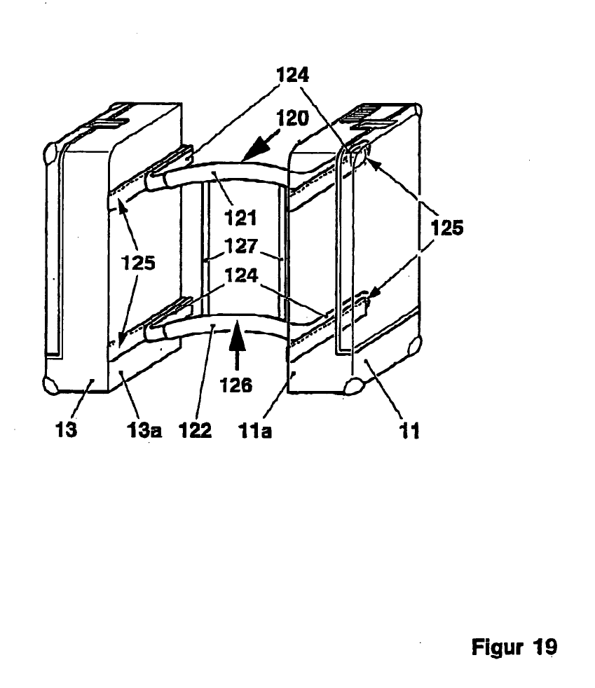

The center compartment 12 (see FIG. 19) displays a carrier frame 120 to which is attached the vest 71 (see FIG. 13). The carrier frame 120 is made of aluminum or carbon fiber and displays a top and bottom support, respectively 121, 122, which are joined via brackets 124 with attaching rails 125, preferably screwed on. The attaching rails 125 are preferably integrated in the case walls 11a or 13a, preferably injected. Furthermore, the supports 121, 122 are bowed in the support area 126 corresponding to the shape of the back, and are joined together by two spacers 127. The carrier frame 120 with vest 72 and parachute 30 in the stand-by condition are tightly locked/covered by the covers 15a, 15b, whereby the covers 15a, 15b are joined/held (together) with the case parts 11 and 12 respectively and/or with the carrier frame 120 by means of connectors not represented in any further detail.

Located in the center compartment 12, which in the stand-by condition is closed and in use is open at the back, front and top, is a so-called round canopy special parachute (SURVIVAL-AIR-GUARD) 30 with a rapidly inflatable opening and stabilizing system 31 based on the air bag system in automobile safety technology, which inflates the parachute in briefest time and keeps it stable in its prescribed form against application of external force, for example impacts against a solid partition, wall or other obstacles, so that it does not lose its efficacy and, by the more rapid opening with the aid of the more rapidly inflating and stabilizing system 31, its functionality is also achieved sooner than in the case of customary and known parachutes.

This rapid opening and stabilizing effect of the special parachute, which displays a canopy that is connected with the parachute harness 70 by means of several rigging lines 112, is achieved by the fact that associated with the canopy 35 is an opening and stabilizing device 31 rapidly unfurling and preferably stabilizing the canopy. The device 31 is attached to the parachute 30, preferably inside the parachute canopy 35, and preferably displays a rapidly inflatable inflation system, preferably with gas generators, preferably an air bag system.

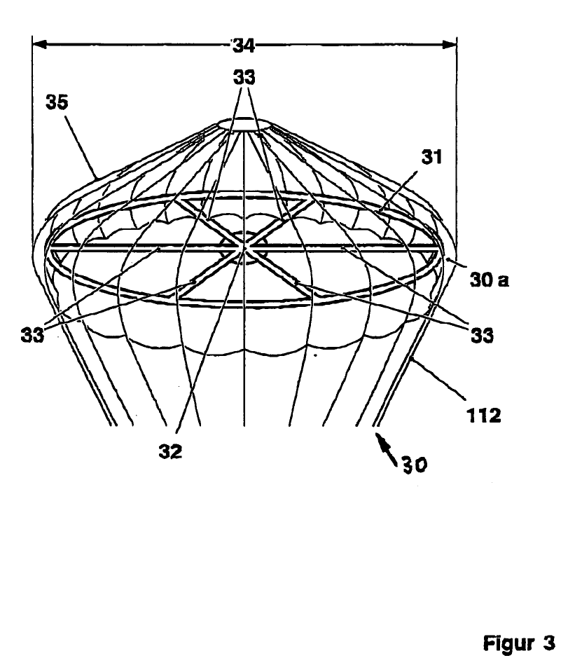

In one form of embodiment of the invention according to FIG. 3, worked into the so-called round-canopy special parachute (SURVIVAL-AIR-GUARD) 30 at the periphery is a ring-shaped hose 31 that is connected at the center 32 of the parachute canopy 35 with six or even more radially disposed channels 33. These channels 33 are collected together or, to be precise, joined at the center 32 and equipped with an accommodating flange for a so-called gas generator, as is customary in motor vehicle safety technology with the known air bag systems.

Connected to this accommodating flange is a suitable gas generator, for example a gas-driven generator from the company Welz lndustrieprodukte GmbH, in Fellbach, having the license number D-ZLS DEKRA 001/00, helium sealed, approval number 9959, which, after ignition by electronic or mechanical means, fills the channel and ring system within the range of milliseconds with a gas that is not harmful to humans, and rapidly opens the special parachute (SURVIVAL-AIR-GUARD) and maintains it in its basic shape. Here the radially disposed channels 33 as well as the ring hose 31 made of gas-impermeable material that is mounted on the external diameter are made such that the degree of filling of the stabilizing system achieves an as great as possible service life. The hoses and channels preferably stitched of silicone or air bag fabric are made gas tight in the area of the stitched longitudinal seams by over-expanding the hose or the channels, e.g. with 3 bar. The expanded and thereby self slightly-opening seam area is completely filled with silicone and sealed. After relaxing the seam area and drawing together of the seam area, this latter is gas tight. Another advantageous embodiment of the hoses or channels consists in that they are woven round and, thereby, consist of round-woven hose and therewith display no longitudinal seams that have to be sealed.

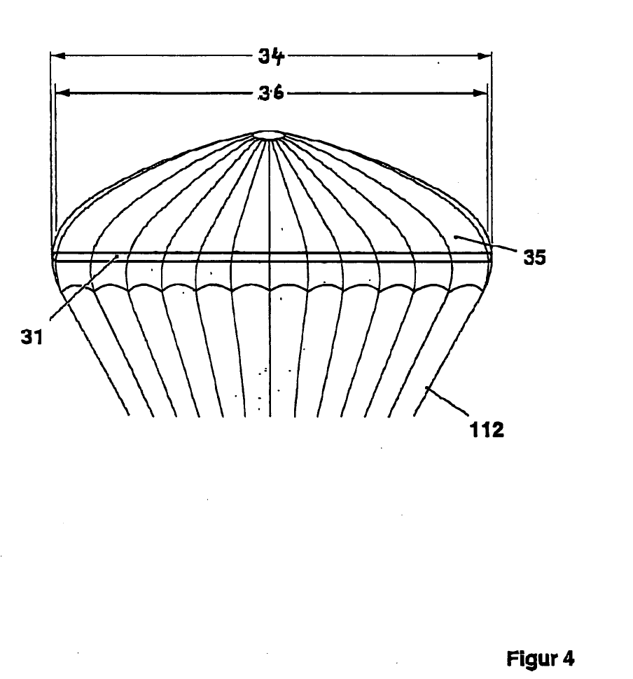

The stabilizing ring hose 31 joined to the outer diameter 34 of the round canopy special parachute (SURVIVAL-AIR-GUARD) 30 is geometrically embodied such that the outer diameter 34 of the parachute canopy 35 is greater than the inner diameter 36 of the stabilizing hose (see FIG. 4). Achieved by this is that the rescue parachute (SURVIVAL-AIR-GUARD) when contacting obstacles does not become caught and slides off better.

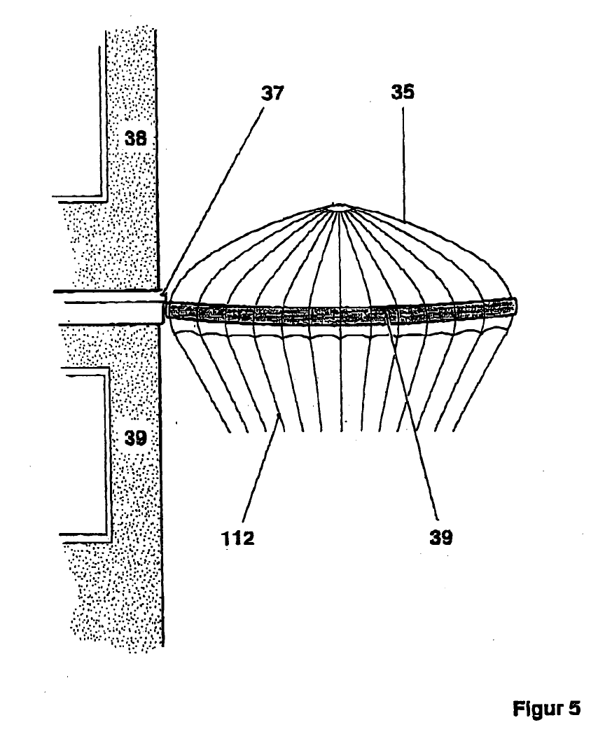

As protection against damage by unknown external influences or also for better sliding off at obstacles, e.g. projections 37 on buildings 38 (see FIG. 5) also additionally capable of being installed on the surface of the parachute outer diameter is a suitable, smooth and rip-fast reinforcing strap 39, preferably reinforced parachute silk or air bag fabric. In addition, form stability of the parachute can also be stabilized with so-called rebound straps.

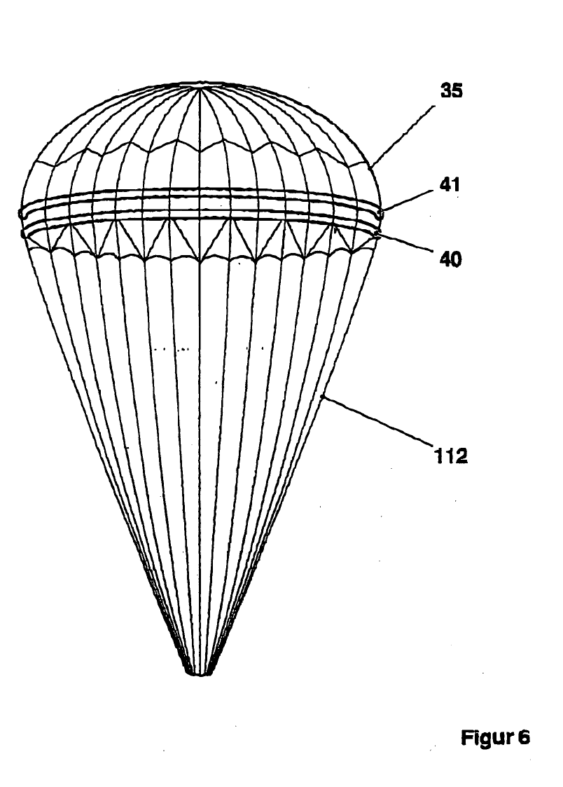

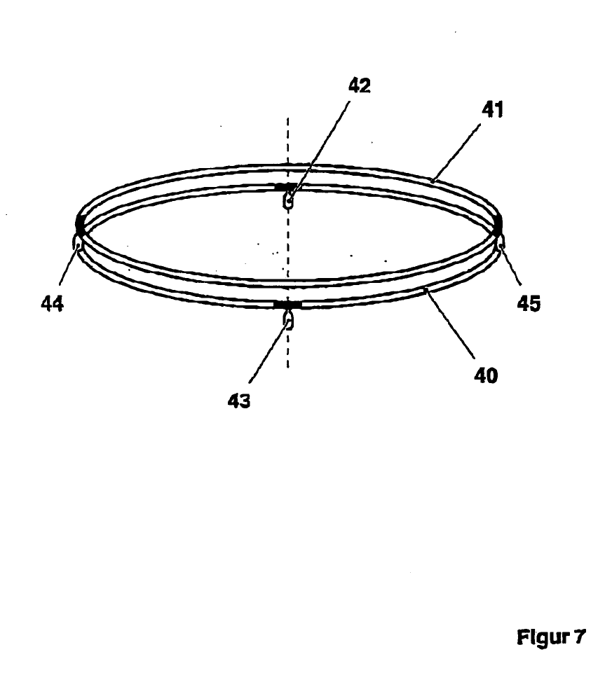

Alternatively, according to FIGS. 6 and 7, rapid inflation and stiffening of the round canopy special parachute (SURVIVAL-AIR-GUARD) can also be accomplished with more than one stabilizing ring, whereby then the channels going toward the center can be omitted and the stabilizing ring hoses 40, 41 arranged one above the other can each be filled by means of one or even more gas generators. Here it is also possible, for example, to use per hose ring two 42, 43, and 44, 45 respectively or more gas generators for filling one hose ring, which also can be ignited in time-delayed fashion. Time-delayed ignition of the gas generators also applies for all gas generators of all additional stabilizing rings.

When using two gas generators per hose ring, the two gas generators 42, 43, and 44, 45 respectively are appropriately oppositely disposed 180° from one another on the periphery (see FIG. 7) in order to equalize the reaction forces.

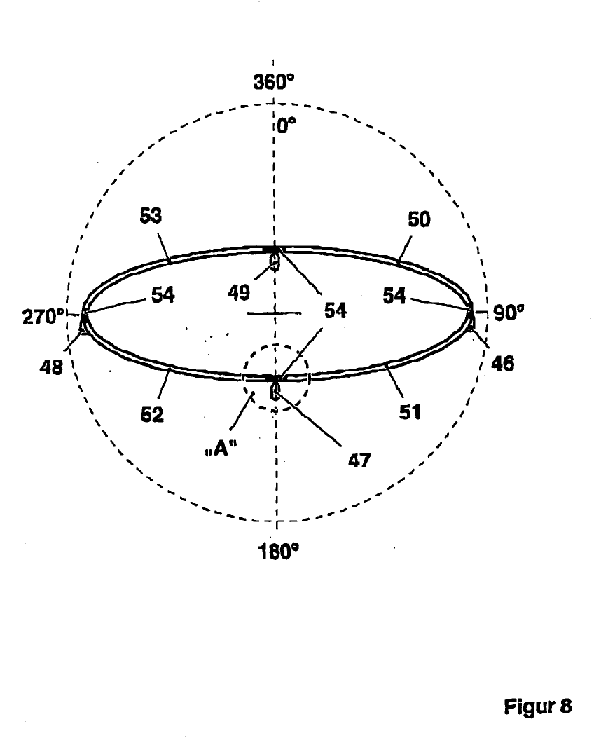

When using four gas generators 46 to 49 per hose ring (see FIG. 8), the four gas generators are appropriately disposed on the periphery at 0°, 90°, 180° and 270° in order to equalize the reaction forces.

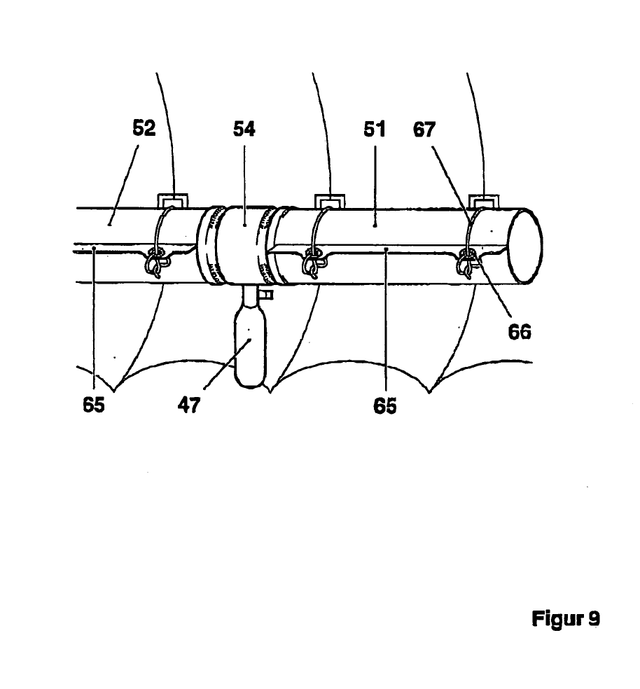

In the case of this advantageous embodiment of the invention, according to FIG. 8 each of the hose segments 50 to 53 are connected together via sleeve joints 54 into which are also connected gas generators 46 to 49. Illustrated in FIG. 9 is the detail “A” of FIG. 8 in an enlarged representation.

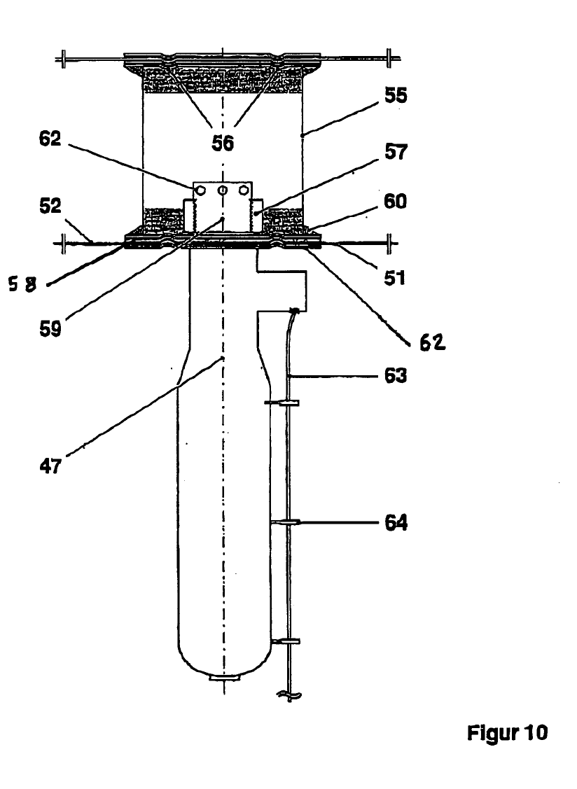

FIG. 10 shows the sleeve joint 54 in cross section, whereby the joint 54 displays a formed part 55 with compression grooves 56 in which a thread 57 is provided for attachment of the gas generator 47. A silicone sealing sleeve 58 with retaining and compression edges 60 is pushed on over the formed part 55, also over the sealing sleeve 58 the hose segments 51 and 52, and over this a protection and compression sleeve 61 made of aluminum, whereby, self-understood, are provided in the sleeves 58 and 61, as well as in the hose segments 51, 52 openings for the gas generator connector 59. Achieved by compressing these parts is a gas-tight sleeve connection 54. The discharge nozzles of the gas generator 47 are designated with 62, the release line for the gas generator with 63 and the guide brackets for the lines with 64. When assembling, first connected together via the sleeve joints 54 are the hose segments 50-53, and then screwed in are the gas generators 46-49, whereby, before screwing in the last gas generator the system is evacuated so that the hose system can be easily collected together into a small package in order to obtain a small volume system. This rapid inflation stabilizing system illustrated in FIG. 8-10 is therewith, in practice, constructively built up such that it can be incorporated as a complete, tested unit into the special parachute (SURVIVAL-AIR-GUARD). In this way it is replaceable within the total system.

The rapidly inflatable stabilizing system 31 can also be equipped externally to the hose seam, at functionally determined intervals, with brackets 65, in which are set easy-slip eyelets 66 through which are guided the ties 67 attached to the special parachute (SURVIVAL-AIR-GUARD), and that can be joined with this latter (see FIG. 9).

Furthermore, ties that loosely (with play) encircle the hoses of the stabilizing system can also be placed on the diameter of the special parachute (SURVIVAL-AIR-GUARD) on the inner side at suitable intervals in order thereby to allow the inflated system freedom of radial movement, so that different properties of expansion within the assembly will be equalized and damages in the operational condition will be avoided.

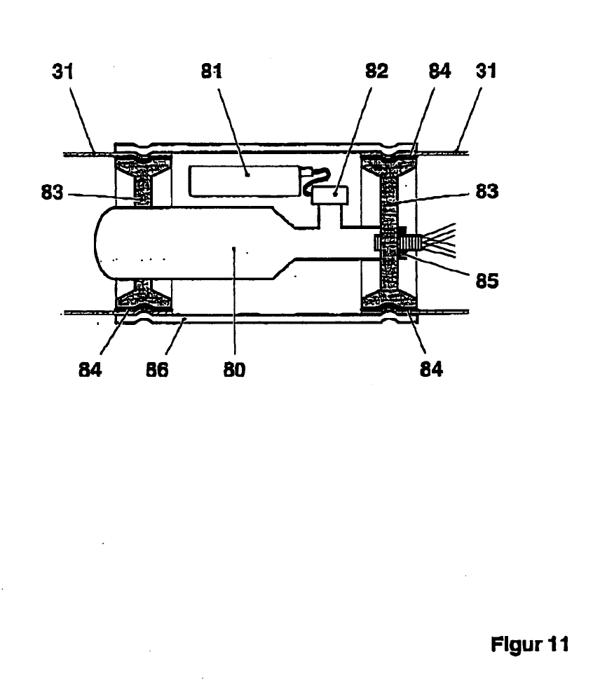

In another advantageous form of embodiment of the invention, the generator(s) is/are disposed within the stabilizing hose 31 (FIG. 11), where the gas generator is designated with 80, the dynamo (generator) for electrical ignition with 81, the igniter with 82, the distributor for the generators with 83, the seal with 84, the locking nut with 85 and the compression sleeve with 86.

Other geometric forms of the rapidly inflatable stabilizing system are also possible, where the positioning of the generators must be coordinated to the function of the stabilizing system.

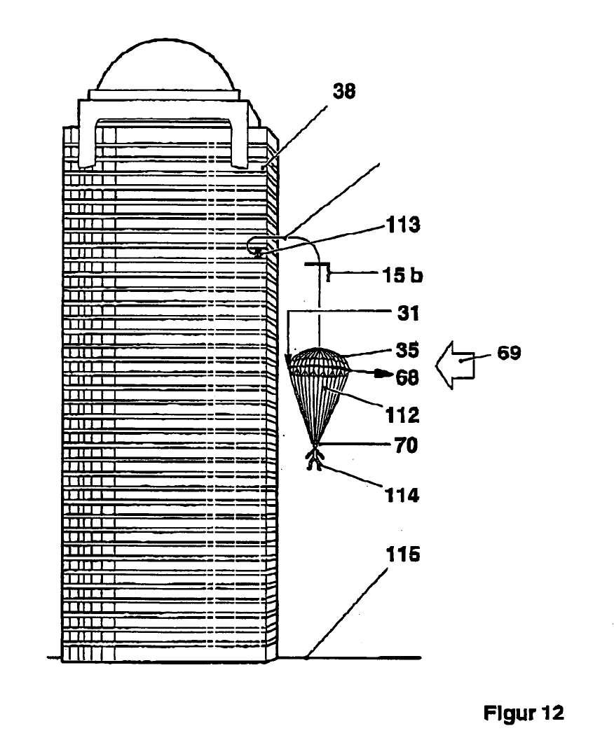

It is significant that the round canopy/special parachute (SURVIVAL-AIR-GUARD) not be brought early into its form corresponding to its purpose only through the speed of flow and entry of air in free fall, but rather also with pyrotechnic support. Through this measure, the special rescue parachute (SURVIVAL-AIR-GUARD) has achieved its carrying and also its stabilized form, and its function is also therewith guaranteed at a lower jump height, about 30 m. Besides this, the stabilizing system generates a spring-back resilience effect in the direction of the arrow 68 and prevents a collapsing of the parachute, for example in the case of collision with buildings 38 caused by a shift in wind in the direction of the arrow 69 (see FIG. 12).

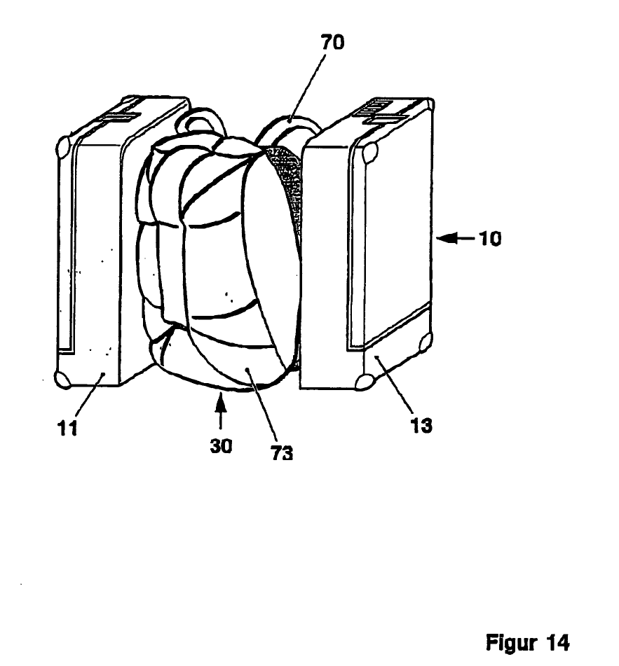

In accordance with FIGS. 13 and 14, the special parachute (SURVIVAL-AIR-GUARD) is also equipped with a harness (belt) system 70 that is in turn firmly joined with a vest 71. The vest 71 is attached to a carrier frame 120 (see FIG. 19) and is located on the front side of the survival case (SURVIVAL CASE), (on the side of the compartment 12 closed by the cover 15a). Correspondingly, the parachute 30 is located on the backside of the center compartment 12, which is closed by the cover 15b. At the same time, the parachute 30 is surrounded by a fire-resistant covering pack 73, whereby for use the parachute 30 is pulled out from the pack by means of a release line 110. Another possibility exists in the parachute 30 being catapulted out from the case/pack provided for the parachute with the aid of a supplementary gas generator, with the associated release mechanism also being actuated over the release line 110.

Alternatively, it is also possible that the vest with harness system be attached to the parachute case (container in which the parachute is folded together). The combination vest with harness system enables the rapid and safe deployment of the rescue system. The harness system cannot become twisted and makes deployment easier, especially in emergency and therewith associated stress situations.

The belts themselves are adjustable in length in relation to the person. In each case they are snapped into colored eyelets with non-interchangeable spring safety hooks 74 that are marked with like color. The vests are padded on the back and breast half and are made of fire-resistant material (like firemen suits). They are provided in all common standard sizes.

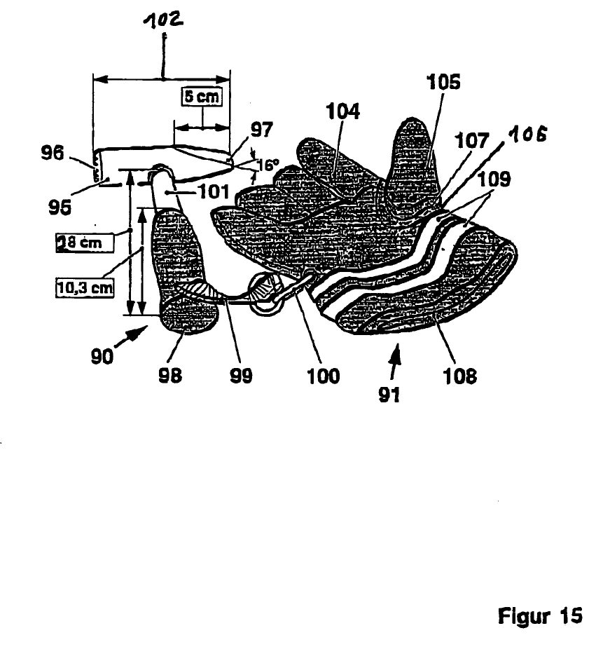

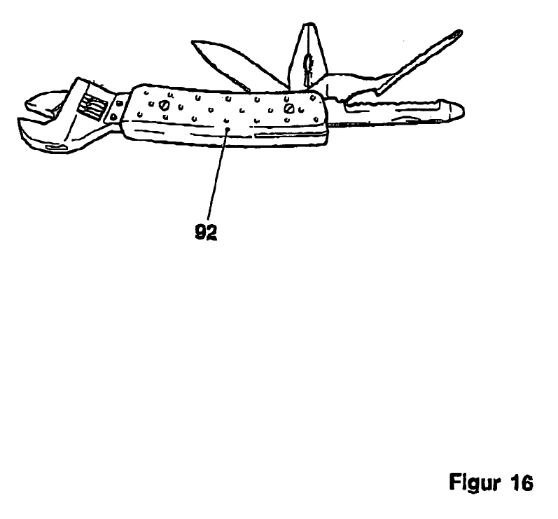

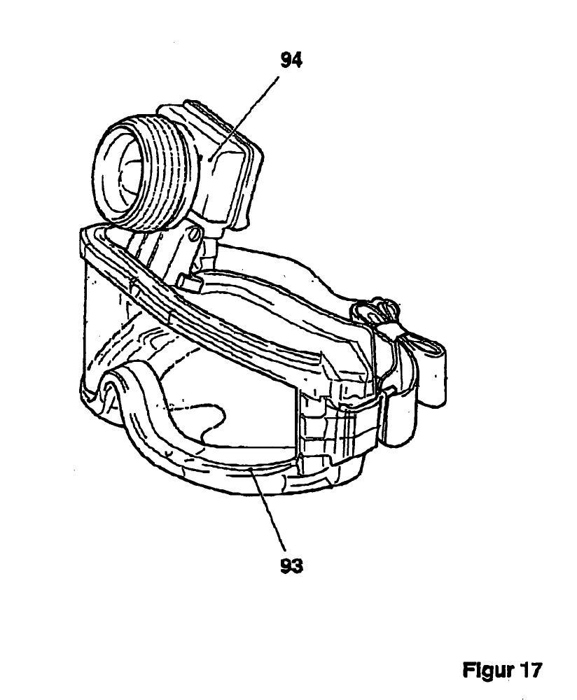

The third compartment 13 of the survival case (SURVIVAL CASE) 10 contains other survival tools and devices. For example, special hammer (survival crasher) 90, with handle for breaking glass panes (FIG. 13), breathing mask, dust mask, emergency bandaging equipment, cord/rope, two gloves 91, in each case for right- or left-handers respectively (FIG. 15), handyman's tool 92 (FIG. 16), adhesive tape, protective eyeglasses 93 with tiltable lamp 94 (FIG. 17) as well also as, under some circumstances, people-related utensils and materials.

The hammer 90 displays a cylindrical shape striker part 95 with a checkered pattern 96, an added forcing wedge 97 (wedge length about 5 cm, wedge angle about 16°), as well as a handle 98, where the cylinder diameter comes to about 30 mm. Attached to the handle 98 with a grip length of about 18 cm is a belt strap 99 that is preferably hooked with a spring safety hook 100 onto protective glove 91. The striker part 95 and forcing head part 97, as well as the hammer shaft 101 are made of stainless steel, while the handle is made of rubber. The hammer length 102 amounts to about 12 cm, the shaft 103 [sic] to about 28 cm, with the shaft diameter to about 18 mm. The weight of the hammer is about 750 grams.

The protective glove 91 displays an inside surface 104 made of leather and an outside surface made of a tear-resistant material. The leather thumb 105, in contrast to a usual glove, is not sewn to the inside surface 104, but rather along the edge 106, whereby the seam socket 107 is sewn in flexibly toward the front and rear so that there is no impairment relative to mobility of thumb in right or left hand usage. Moreover, placed on the outer surface as well as on the glove gauntlets 108 are reflective applications 109, in order, in case of darkness, to be able to better recognize the glove 91 with the associated hammer 91.

Guaranteed by the glove/hammer combination is that when breaking glass panes or the like the hammer can not slip or fly away, and the possibility of quick use and application is given for the right- and/or left-handers.

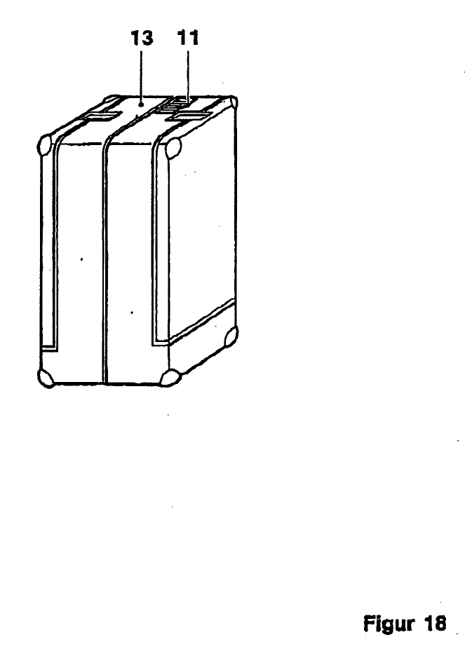

The 3-section survival case (SURVIVAL CASE), among other things, also has the advantage that by its variable construction it offers the possibility, by removal of the carrier frame 120 and the covers 15a and 15b, to directly combine into a 2-compartment case (see FIG. 18) the two outer compartments 11, 13 using the same adaptation locks, in which are now still found only the survival tools and equipment (without the special parachute.) This offers the possibility of equipping the survival case (SURVIVAL CASE) according to need. That is, for example, when the outside conditions clearly make recognizable in advance that only the breathing or smoke protection equipment, along with rescue tools, are needed, or possibly only the rescue parachute (SURVIVAL-AIR-GUARD). Through this possibility for variation, use of the life-saving device is also cost-favorably possible in targeted fashion.

The locking covers 14, 16, fitted on the outside compartments of the SURVIVAL CASE, can be furnished with emblems, symbols, pictures or even operating instruction texts. This can be done with posters, labels or also airbrushed on with a painting process.

Description of Operation/Release Procedure for the Parachute:

A) Open the two covers 14, 16.

B) Remove cover 15a in the center section 12. Cover 15b remains closed and, basically, is preferably not to be opened from the outside, so that no changes and/or manipulations of the parachute are possible.

C) Remove the needed equipment and tools from the compartments 11, 13.

D) Pull on the vest 71 and with it the case 10 with the parachute 30, and lock the harness system 70, 74.

E) If necessary, with the hammer 90 smash a glass pane (door, window or the like.)

F) A release line (thin steel cord) 110 rolled up on the vest 71 and connected serially, first with the cover 15b and then with the parachute 30 or the harness system 70 (see FIG. 13), is removed from the vest and (see FIG. 13) with a spring hook 111 attached thereto is attached to some item 113 located near the glass pane and/or another outside-facing building opening, e.g., a radiator, desk leg, office chair, window cross bar or the like (see FIG. 12.)

G) The person 114 jumps as far away from the building as possible.

H) The release line 110, which is connected with the cover 15b and the parachute 30 tightens and first pulls the cover 15b from its mounting in the center compartment 12 and then the parachute from the parachute pack.

I) The connecting lines 112 of the parachute 30 to the harness system 70 tighten, at first by the free fall of the person.

J) At the same time, the air bag release line 64, maintained shorter than the rigging line 112 of the parachute 30 and also connected to the harness system 70, tightens. The gas generator(s) is/are ignited (mechanically or electrically) and the parachute canopy 35 is rapidly inflated by the inflation and stabilizing system 31, and the chute is opened as well as stabilized.

K) At a preset point, the release line 110 is separated from the parachute 30. The line 110 with the cover 15b attached to it remains hanging loosely to the attached spring hook 111.

L) The person 114 glides safely to the ground 115 by means of the parachute.

1. Parachute, in particular round canopy parachute, wherein that integrated in the round canopy special parachute (SURVIVAL-AIR-GUARD) (30) is a rapidly inflatable stabilizing system (31) that inflates the parachute in shortest time and, against force brought against it from the outside, maintains it stably in its prescribed form and therewith capable of functioning.

2. Parachute according to claim 1, wherein the inflating and stabilizing system (31) of the special parachute (SURVIVAL-AIR-GUARD) is inflated with one or several gas generators (42-45, 46-49) similar to the air bag system in motor vehicle safety.

3. Parachute according to claim 2, wherein the inflation and stabilizing system (31) of the round canopy special parachute (SURVIVAL-AIR-GUARD) (30) is made of gas-impermeable material, so that the stabilizing system has an as long as possible service life.

4. Parachute according to claim 3, wherein worked into the round canopy special parachute (SURVIVAL-AIR-GUARD) (30) on the periphery is a flexible ring hose (31) made of gas impermeable material, which is joined with only two to six or more radially-disposed channels (33) out from the center (32) of the chute (30) and is connected to one or several gas generators.

5. Parachute according to claim 4, wherein the stabilizing hose (31) is embodied geometrically in cross section such that the outside diameter (34) of the parachute canopy (SURVIVAL-AIR-GUARD) (30) is greater than the inside diameter (34) of the stabilizing ring hose (31).

6. Parachute according to claim 5, wherein installed on the surface of the parachute outer diameter, as protection against damage by unknown external action or also for better sliding against obstacles (37), is a smooth, tear-fast reinforcing strap (39).

7. Parachute according to claim 6, wherein the form stability of the round canopy special parachute (SURVIVAL-AIR-GUARD) can also be additionally stabilized with so-called rigging lines.

8. Parachute according to claim 7, wherein the round canopy special parachute (SURVIVAL-AIR-GUARD) (30) is equipped with more than one stabilizing ring (39, 40 or 41,42), whereby in the individual case, or also generally the channels leading to the center are omitted.

9. Parachute according to claim 8, wherein the ring form stabilizing hoses (39, 40 or 41, 42) are arranged one over the other on the inner wall of the parachute (SURVIVAL-AIR-GUARD) (30).

10. Parachute according to claim 9, wherein the individual stabilizing hoses (39, 40 or 41, 42) can be filled with one or even more gas generators (42, 43 or 44, 45 or 46 to 49, or 80).

11. Parachute according to claim 10, wherein when using two (42, 43 or 44, 45), or even, for example, four gas generators (46 to 49) in a stabilizing ring, the gas generators can also be ignited in time-delay fashion.

12. Parachute according to claim 11, wherein when using two gas generators (42, 43 or 44, 45) per stabilizing ring (40 or 41) the generators are appropriately arranged 180° apart on the periphery of the ring.

13. Parachute according to claim 12, wherein when using four gas generators (45 to 49) per stabilizing ring (51), the gas generators are appropriately arranged on the periphery of the ring at 0° and 90° and 180° and 270°.

14. Parachute according to claim 13, wherein when employing several stabilizing hoses, all gas generators incorporated for inflation can be ignited in time delay fashion.

15. Parachute according to claim 14, wherein the round canopy special parachute (SURVIVAL-AIR-GUARD) is equipped with only one stabilizing ring (31), where the gas generator(s) (80) is/are arranged inside the stabilizing hose (31).

16. Parachute according to claim 15, wherein the stiffening hoses (31, 33, 40, 41, 50 to 53) or preferably the complete stiffening system is made as a unit, and later can be incorporated into the special parachute (SURVIVAL-AIR-GUARD), and is therewith replaceable.

17. Parachute according to claim 16, wherein the stabilizing system can also optionally be mounted in radially displaceable fashion and flexibly with ties (67) or loops (eyelets) placed on the special parachute (SURVIVAL-AIR-GUARD).

18. Parachute according to claim 17, wherein the rescue parachute (SURVIVAL-AIR-GUARD), which is equipped with a rapid inflation and stabilizing system, can also have forms other than a round canopy parachute, for example like sporting jump chutes, paraglide chutes, reserve sport chutes, or other geometric forms.

19. Parachute according to claim 18, wherein the stabilizing ring(s) worked into the special parachute (SURVIVAL-AIR-GUARD) (30) can be made up of individual hose segments (50 to 53) by means of connector sleeves (54), whereby the gas generators (46 to 49) are attached at the connector locations (54).

20. Parachute according to claim 19, wherein the rapidly inflatable stabilizing system of the special parachute (SURVIVAL-AIR-GUARD) can be filled from one or several gas generators, or also from a gas-filled pressure bottle, whereby the pressure producers are not attached within the special parachute, but rather centrally in the middle compartment (12), and filling of the stabilizing system (31) then follows preferably over a hose system connecting the gas generator and/or pressure gas bottle with the stabilizing system.

21. Parachute according to claim 20, wherein it is integrated in a survival case (10) having three (11, 12, 13) or even more compartments in which all equipment or tools needed for an emergency are accommodated in the order based on the functional procedure.

22. Parachute according to claim 21, wherein it is incorporated in the center compartment (12), which in stand-by condition is closed and in use is open at the back, front and top.

23. Parachute according to claim 22, wherein the round canopy special parachute (SURVIVAL-AIR-GUARD) (30) is equipped with a harness system (70) that is, in turn, firmly joined with a vest (71) and that is firmly mounted on the front side 72 of the survival case (SURVIVAL CASE) (10).

24. Parachute according to claim 23, wherein the belts of the harness system are adjustable in length relative to the person—according to size—and can be hooked on with quick-connect spring safety hooks (73), or other quick-connect fasteners.

25. Parachute according to claim 24, wherein the two outer compartments (11,13) can also be combined into a separate 2-compartment case with the same adaptation fasteners, wherein are located only the survival tools, and the center compartment (12) with the special parachute (SURVIVAL-AIR-GUARD) (30) and the two outer compartments (11, 13) can be used as individual units, independent of each other.

26. Parachute according to claim 25, wherein located in the survival case (10), among other things, is a special hammer (WINDOW CRASHER) (90) that is joined with a hand strap (99) and with a protective glove (91), and is also suitable for breaking heavy (glass) panes and the pane splinters, and that the protective glove (91) displays a thumb (105) having a movable socket (107) and, therewith, the protective glove (91) can be used equally by right- and left-handers.

27. Parachute according to claim 26, wherein the protective glasses (93) contained in the survival case (10) are provided with a tiltable lamp (94) that is, in turn, provided with a forehead protector, and that the protective glasses (93), because of their size, can also be used by eyeglass wearers.

28. Parachute according to claim 27, wherein the breathing device (20) located therein displays, optionally, a mouthpiece and nose clip or a mouth/nose breathing mask (22).

29. Parachute according to claim 28, wherein the breathing device (20) is also equipped with several hose outlets (25) for use of two or more persons.

30. Parachute according to claim 29, wherein the special hammer (window crasher) (90) located in the survival case (10) displays a striker part (98) [sic] and a forcing wedge (97), so that glass panes can be smashed through and, e.g., doors can be burst open.
